(19) United States
(12) Patent Application Publication
(10) Pub. No.: US 2023/0365779 A1
(43) Pub. Date: Nov. 16, 2023

(54) ITEM MADE OF A HEAVY PLASTIC MATERIAL

(71) Applicant: ETA SA Manufacture Horlogère Suisse, Grenchen (CH)

(72) Inventors: Julien DAHAN, Delemont (CH); Benoît SCHNELL, Grenchen (CH)

(73) Assignee: ETA SA Manufacture Horlogère Suisse, Grenchen (CH)

(21) Appl. No.: 18/302,065

(22) Filed: Apr. 18, 2023

(30) Foreign Application Priority Data
May 11, 2022 (EP) 22172730.8

(51) Int. Cl. C08K 3/20; C08L 77/00; C08K 3/34

(52) U.S. Cl. CPC C08K 3/20; C08L 77/00; C08K 3/34; C08K 2003/2244

(57) ABSTRACT

An item made of a material including by weight: a metallic and/or ceramic filler present in a percentage greater than or equal to 50% and less than or equal to 85%, at least one polymer present in a percentage greater than or equal to 15% and less than or equal to 50%, the polymer being bonded to the filler. The polymer can include a hydrogen bond donor which is a group NHx adjacent to a hydrogen bond acceptor which is a group C═O; so as to form a unit —[(C═O)NH]—; and the unit —[(C═O)NH]— representing at least 1% molar of the polymer.

### TECHNICAL FIELD OF THE INVENTION

The present invention relates to an item, and for example to a horological component, made of a heavy and shock-resistant plastic material.

The present invention also relates to a process for manufacturing such an item made of a heavy plastic.

### TECHNOLOGICAL BACKGROUND

Numerous external part components, such as middles and bracelets, are made of plastic materials. These components can be produced using moulding processes, which offers the advantage of being able to obtain various shapes without any correction operation. These plastic material components have the feature of having a density close to 1 and therefore of being light. This can represent a disadvantage for the user seeking to wear a watch having a certain weight on their wrist.

To remedy this drawback, it has been proposed, for example in the document EP 2 482 142, to produce horological components, whether they are movement or of external part components, of plastic materials charged with a high-density metallic powder such as a tungsten powder. These components are produced using an injection moulding process which makes it possible to retain the advantage of shaping in the mould without subsequent correction while increasing the density thereof.

These materials thus combine certain advantages of plastics such as ease of shaping by injection with those of metals such as density, cold touch and metallic appearance.

However, a decrease in rupture and elongation resistance compared to the host polymeric matrix can be observed in these materials. This decrease is attributed to a lack of cohesion of the material due to the incorporation of metallic powder of micrometric size into polymer chains of nanometric size. This drop in properties due to the lack of cohesion of the material is thus observed for a material comprising a metallic (or ceramic) filler, a polyolefin (polyethylene, polypropylene) as polymer and polyurethane as coupling agent.

This decrease in mechanical properties will impact the shock absorption capacity of the material. This type of material is therefore not suitable for applications requiring a shock resistance, such as for example in the horological field for producing middles, etc.

### SUMMARY OF THE INVENTION

The aim of the present invention is that of providing a novel heavy plastic material composition for enhancing the cohesion of the material and thereby the mechanical properties of the material.

The invention finds a particularly interesting application in the field of watchmaking; however, the invention is not limited to such an application.

To this end, the present invention provides an item made of a material comprising by weight for a total of 100%:
a filler made of a metallic and/or ceramic material having a density greater than or equal to 3 g/cm³, said filler being present in a percentage greater than or equal to 50% and less than or equal to 85%,
at least one polymer present in a percentage greater than or equal to 15% and less than or equal to 50%,
optionally at least one coupling agent present in a percentage greater than or equal to 0% and less than 10%,
optionally at least one reinforcement present in a percentage between 0 and 10%,
optionally at least one pigment present in a percentage between 0 and 5%,
optionally at least one extender and/or one plasticiser present in a percentage between 0 and 5%.

According to the invention, the polymer is bonded to the filler, and/or the coupling agent is bonded respectively to the filler and to the polymer, when the material includes at least one coupling agent, by one or more hydrogen bonds.

The polymer, and/or the coupling agent, includes a hydrogen bond donor which is a group NHₓ adjacent to a hydrogen bond acceptor which is a group C═O; so as form a unit —[(C═O)NH]—.

The unit —[(C═O)NH]— represents at least 1% molar of the polymer, and/or of the coupling agent.

These hydrogen bonds bonding the filler, the polymer and where applicable the coupling agent make it possible to ensure good cohesion of the material. They have the feature of having an interaction energy which is typically less than 100 kJ/mol, or 50 kJ/mol, which makes it possible to break the bonds between molecules during the temperature rise during the manufacturing process and thereby ensure better mixing and better cohesion of the material after cooling and reformation of the bonds.

The material according to the invention has a sufficient rigidity with a Young's modulus greater than or equal to 2.5 GPa, a sufficient elongation at break which is greater than or equal to 5% and a sufficient tensile strength which is greater than or equal to 30 MPa, for a horological application. It furthermore has a good toughness and a density between 2 and 7 g/cm³.

In addition to the features mentioned in the preceding paragraph, the item according to the invention can have one or more complementary features from among the following, considered either on an individual basis or according to any combination technically possible:
the filler is present in a weight percentage between 60 and 80% and in that the polymer is present in a weight percentage between 20 and 40%;
the filler is present in a weight percentage between 65 and 75% and in that the polymer is present in a weight percentage between 25 and 35%;
the filler is present in a weight percentage between 50 and 75% and in that the polymer is present in a weight percentage between 25 and 50%;
the filler is present in a weight percentage between 50 and 65% and in that the polymer is present in a weight percentage between 35 and 50%;
the coupling agent is present in a weight percentage between 0.1 and 10%;
the coupling agent is present in a weight percentage between 0.1 and 5%;
the coupling agent is present in a weight percentage between 0.5 and 3%;
the metallic and/or ceramic material comprises on the surface oxides, hydroxides and/or electron holes involved in hydrogen, coordination and ionic bonds with the polymer and/or the coupling agent;
the polymer and/or the coupling agent carry one or more groups chosen from NHₓ, OH, COC, C═O and COOH;
the polymer is a polyamide, preferably a polyamide 11;
the coupling agent is a polyurethane;
the polymer is bonded to the filler and/or, when the material includes at least one coupling agent, the coupling agent being respectively bonded to the polymer and to the filler by one or more ionic bonds, the polymer carrying a group NHₓ+ bonded to an anion of the filler and/or the coupling agent;
the filler carries an anion O—;
the coupling agent carries an anion R—COO—;
the polymer is bonded to the filler and/or, when the material includes at least one coupling agent, the coupling agent being respectively bonded to the polymer and to the filler by one or more coordination bonds, with the polymer and/or the coupling agent carrying amine or carboxylic acid functions forming said coordination bond with an electron hole on the surface of the filler;
the coupling agent includes at least 20 carbon atoms;
the material includes the filler and the polymer which is a polyurethane, without addition of said coupling agent;
the material includes the filler with polyamide as polymer and polyurethane as coupling agent;
the material includes, for a percentage of 100%, said filler in a percentage between 65 and 80%, said polymer in a percentage between 19.5 and 34.5%, and said coupling agent in a percentage between 0.5 and 5%;
the material includes, for a percentage of 100%, said filler in a percentage between 65 and 75%, said polymer in a percentage between 24 and 34%, and said coupling agent in a percentage between 1 and 3.5%;
the material includes, for a percentage of 100%, said filler in a percentage between 50 and 75%, said polymer in a percentage between 24.5 and 49.5%, and said coupling agent in a percentage between 0.5 and 5%;
the material includes, for a percentage of 100%, said filler in a percentage between 50 and 65%, the polymer in a percentage between 34.5 and 49.5%, and said coupling agent in a percentage between 0.5 and 5%;
the material includes the filler with polyamide as polymer and hydroxysilane with an amide or amine function as coupling agent;
the material includes the filler with polyester as polymer and hydroxysilane with an amide or amine function as coupling agent;
the reinforcement is present in a weight percentage between 1 and 6%;
the reinforcement is formed of glass fibres, glass beads, carbon fibres and/or aramid fibres;
the item is a horological external part or movement component.

Furthermore, the present invention relates to a process for manufacturing this material by moulding, by injection or by 3D printing.

The process has the feature that the base material for the filler is in the form of a powder having a BET greater than or equal to 0.01 m²/g, preferably 2 m²/g, more preferably 5 m²/g, so as to obtain a filler with a sufficiently reactive surface area to form hydrogen bonds, and optionally complementary ionic and/or coordination bonds, with the polymer and/or the coupling agent if the latter is present. The reactive surface area regardless of the type of ceramic (oxides, nitrides or carbides) or metal (steel, tungsten, etc.) thus includes hydroxides, oxides and/or electron holes.

Further features and advantages of the present invention will become apparent in the following description of a preferred embodiment, given by way of non-limiting example with reference to the appended drawings.

### BRIEF DESCRIPTION OF THE FIGURES

FIG. 1 represents a timepiece comprising a middle made of the heavy plastic material according to the invention.

FIG. 2 schematically represents the interactions between the surface of the filler, the coupling agent and the polymer.

FIG. 3 schematically illustrates the hydrogen bonds formed between the filler, the coupling agent and the polymer.

### DETAILED DESCRIPTION OF THE INVENTION

The present invention relates to an item made of a composite material comprising a plastic material and a metallic or ceramic material.

For example, the item can be a constituent element of watches, pieces of jewellery, bracelets, etc.

The item can also be a constituent element of a bezel, for example a mount, an arm, a base.

In a non-limiting and non-exhaustive manner, the item according to the invention can also be a constituent element, or form the entirety, of an item of sporting goods, an item of cookware, a musical item or instrument, an item of leatherware or haberdashery, an automotive or aeronautical component, a component for an electronic item (for example, protective telephone case, computer keyboard, computer keyboard keys, headset, etc.), a writing implement, etc.

Advantageously, the item is a component or a part of a component, the function whereof requires a certain resistance to impacts and shocks.

In the specific field of watchmaking, this item can be for example an external part component such as a middle, a back, a bezel, a button, a bracelet link, a dial, a hand, a dial index, etc.

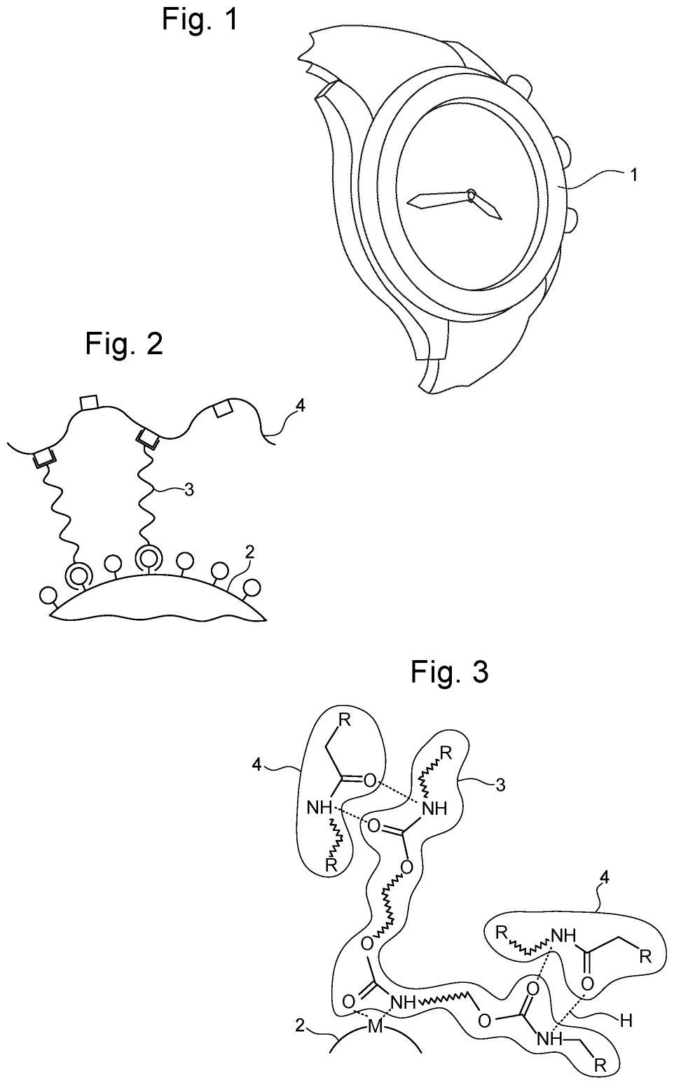

By way of illustration, a middle 1 made of the material according to the invention is represented in FIG. 1.

According to another embodiment example (not shown), the item according to the invention can be a component of the movement, such as for example a plate.

According to the invention, the item is made of a material including two main components which are a metallic and/or ceramic filler, and a polymer. Thus, the material can be described as a composite material.

Optionally, the material can include one or more coupling agents if the physicochemical interaction between the filler and the polymer is not sufficient according to the type of application, and if it is sought to increase the already enhanced shock resistance of the material according to the invention even further.

Optionally, the material can also include a reinforcement.

Optionally, the material can also include one or more pigments.

Optionally, the material can also include extenders and/or plasticisers.

The filler can be metallic and/or ceramic.

The metallic material can consist of a conventional carbon steel, a stainless steel, copper, a copper alloy, titanium, a titanium alloy or tungsten. Preferably, it consists of a nickel-free stainless steel.

The ceramic material can consist of carbides, nitrides or oxides such as ZrO₂, CeO₂, ZnO, etc.

It can also consist of a filler including a mixture of metallic and ceramic materials.

The filler is present in a percentage greater than or equal to 50% and less than or equal to 85% by weight of the material.

For example, the filler is between 50 and 75% by weight (inclusive) of the material.

For example, the filler is between 50 and 65% by weight (inclusive) of the material, if a relatively low density of the material is sought.

For example, the filler is between 60 and 80% by weight (inclusive) of the material, if it is sought to increase the density of the material further, for example between 65 and 75% by weight.

Advantageously, in the examples described above, the filler as a whole is majority by mass, i.e. greater than 50% by weight of the material.

According to the invention, the filler is introduced during the manufacturing process in the form of a powder with a high specific surface area 0.01 m²/g) which de facto, in the absence of specific treatment, will have on the surface thereof modifications of the composition thereof and/or defects, regardless of the type of metallic or ceramic filler. It can consist of oxides or hydroxides present on the oxidised surface of the powder and of defects such as electron holes, which will make it possible to interact via different hydrogen bonds with the polymer and/or the coupling agent if the latter is present. FIG. 2 thus schematically illustrates the interactions established between the surface of the filler 2, the coupling agent 3 and the polymer 4, when the material includes a coupling agent.

The material includes one or more polymers capable of generating hydrogen bonds, and optionally in addition to the ionic and/or coordination bonds, with the filler and/or the coupling agent when it is present. All these physicochemical bonds, and particularly hydrogen bonds, have the feature of having a low interaction energy, typically between 5 and 100 kJ/mole, which makes it possible to break the bonds between molecules during the temperature rise during the injection or 3D printing of the materials, these physicochemical bonds being reformed during the cooling of the material after injection or 3D printing. This feature enables better mixing, better compatibility between the components and as such better cohesion of the material on a molecular scale and therefore better overall cohesion of the material.

The polymer or the set of polymers represents a weight percentage between 15 and 50% of the material (inclusive).

For example, the polymer or the set of polymers represents a weight percentage between 25 and 50% of the material (inclusive).

For example, the polymer or the set of polymers represents a weight percentage between 35 and 50% of the material (inclusive).

For example, the polymer or the set of polymers represents a weight percentage between 20 and 40% of the material (inclusive), for example between 25 and 35% by weight of the material.

When the filler is majority in the material, the polymer or the set of polymers represents a percentage less than 50% by weight.

Advantageously, the polymer, or the set of polymers, is chosen to form hydrogen bonds with the filler. To this end, the polymer, or the set of polymers, including a hydrogen bond donor comprising a group with a hydrogen atom, such as an NH or OH group, and a hydrogen bond acceptor comprising a group with a more electronegative atom than hydrogen, such as nitrogen, oxygen or an atom of the halogen group such as fluorine, chlorine, bromine, etc. The hydrogen bond is formed with the hydroxides and oxides present on the oxidised surface of the metallic or ceramic filler.

For example, the hydroxide group on the surface of the filler interacts with a group C═O, R—OH, COC, R—NHₓR′ of the polymer.

Preferably, the hydrogen bond donor and acceptor are adjacent on the polymer chain.

Preferably, the polymer, or the set of polymers, includes a hydrogen bond donor which is a group NHₓ adjacent to a hydrogen bond acceptor which is a group C═O, so as form a unit —[(C═O)NH]—.

Preferably, the polymer, or the set of polymers, can be a polyamide of chain R—C(═O)—NH—R′, and therefore including the unit —[(C═O)—NH]—, with therefore the group C═O comprising the bond acceptor oxygen atom and the group N—H comprising the bond donor hydrogen atom which are adjacent.

Preferably, the unit —[(C═O)—NH]— represents at least 1% of the chain of the polymer, or of the set of polymers.

Preferably, the polymer is a biosourced polyamide of renewable origin, for example a polyamide 11.

In addition, ionic and/or coordination bonds can be formed between the polymer and the filler to create additional interactions and further enhance the cohesion of the material.

The ionic bonds within the scope of the invention result from the interaction between a negatively-charged basic function and a positively-charged acid function. The bond is formed with transfer of an ion H⁺ from a group OH on the surface of the metallic or ceramic filler to the polymer. For example, the polymer can include a group NHₓ and more specifically be a polyamine, obtaining R—NHₓ₊₁—R′+/MO— after the acid-base reaction.

The coordination bonds are a specific type of covalent bond where the doublet of common electrons is only obtained from one of the atoms as opposed to the conventional covalent bond where one electron is obtained from each on the bonded electrons. According to the invention, this bond involves more specifically a Lewis base formed by the polymer, associated with an electron hole on the surface of the filler forming the Lewis acid. Any polymer carrying a function including an atom carrying non-bonding pairs can share this pair to “stabilise” the electron hole. It can for example consist of the non-bonding pair of nitrogen or oxygen in R(C═O)NR′, in RO(C═O)NR′ and in R(C═O)OR′. The polymer can also carry amine (NHₓ) or carboxylic acid (COOH) functions capable of forming this bond with an electron hole on the surface of the filler. Mention can for example by made of polyurethanes and polyesters.

The material can include a coupling agent in a percentage between 0% and less than 10%, advantageously between 0.1 and 10%, more advantageously between 0.1 and 5%, even more advantageously between 0.5 and 3%.

The use of a coupling agent makes it possible to enhance further the mechanical characteristics of the item made of such a material according to the invention, and particularly shock resistance.

The coupling agent is capable of being bonded to the filler and to the polymer by one or more hydrogen bonds primarily. The hydrogen bonds between the filler and the coupling agent as well as between the polymer and the coupling can replace or supplement the hydrogen bonds between the polymer and the filler, according to the nature of the polymer used.

Ionic and/or coordination bonds as described hereinabove can also create additional interactions and further enhance the cohesion of the material, i.e. between the coupling agent and the filler and between the coupling agent and the polymer.

It will be specified that in the presence of a coupling agent, the hydrogen bond is formed mainly between the coupling agent and the filler and between the coupling agent and the polymer without necessarily direct hydrogen bonds between the filler and the polymer. As for the polymer, the coupling agent can include at least one group chosen from C═O, COC, OH, NHₓ or COOH.

Preferably, the hydrogen bond donor and acceptor are adjacent on the coupling agent chain.

Preferably, the coupling agent includes a hydrogen bond donor which is a group NHₓ adjacent to a hydrogen bond acceptor which is a group C═O, so as form a unit —[(C═O)—NH]—.

Preferably, the unit —[(C═O)—NH]— represents at least 1% of the chain of the coupling agent.

Preferably, the coupling agent is a polyurethane including the unit —[O—C═O—NH]—.

Preferably, the coupling agent has a long chain with at least 20 carbon atoms.

Again by way of example, the coupling agent can be a hydroxysilane with an amide or amine function and advantageously at least 20 carbon atoms on the chain, to enable hydrogen, ionic and/or coordination bonds.

Again by way of example, the coupling agent can also create ionic bonds with an acid-base reaction taking place during the manufacturing process between the filler and the coupling agent with transfer of an ion H⁺ from a group OH on the surface of the filler.

The coupling agent can also create ionic bonds between the coupling agent and the polymer comprising one or the other respectively of the carboxylic acid R—COOH and amine R—NHₓ functions forming the base, obtaining RCOO—/R′—NHₓ₊₁+ after the acid-base reaction.

Alternatively, the polymer and the coupling agent can be already charged before being contacted. In this case, for the example above, the coupling agent and the polymer respectively carry either the basic function RCOO—, or the acid function R′—NHₓ₊₁+.

Optionally, the material can also include a reinforcement in a weight percentage between 0 and 10%, preferably between 0% exclusive and less than or equal to 10%, advantageously between 1 and 6% (inclusive). The reinforcement can be present in different forms, for example, in the form of fibres or particles. For example, it can consist of glass fibres, glass beads, carbon fibres and/or aramid fibres with a fibre length less than or equal to 300 μm, and, preferably, 200 μm. The purpose of the reinforcement is to enhance the toughness of the material, limit the shrinkage of the material during injection and/or enhance the electrical conductivity of the material.

Optionally, the material can also include one or more pigments in a total percentage between 0 and 5% by weight, preferably between 0% exclusive and less than or equal to 5%. The pigment can be an organic or mineral pigment. For example, it can consist of carbon black for black, dicetopyrrolopyrrole for red (e.g. Irgazin Red K3840LW from BASF), copper phthalocyanine for blue (e.g. Heliogen Blue K7096 from BASF), a monoazo pigment for yellow (e.g. Paliotol Yellow K1760 from BASF), etc.

Optionally, the material can also include extenders and/or plasticisers such as waxes (paraffins) or other application resins (terpenic, phenolic, etc.) to facilitate implementation during manufacture, all of these extenders and plasticisers being between 0 and 5% by weight, preferably between 0% exclusive and less than or equal to 5%.

For example and as represented in FIG. 3, the material includes the metallic filler M and/or the ceramic filler 2 with polyamide as polymer 4 and polyurethane as coupling agent 3 with preferably at least 20 carbon atoms. Preferably, the polymer 4 is a polyamide 11.

The polyamide P11 is of renewable origin as it is derived from castor oil. Thus, the material provided by the invention is a biosourced material.

In this example, the hydrogen bonds between the polymer, the coupling agent and the filler are symbolised by dotted lines.

For example, the material includes, for a weight percentage of 100%:
the metallic filler, such as a stainless steel, and/or ceramic filler such as a zirconium oxide in a percentage between 65 and 80% by weight, for example between 65 and 75%, or between 50 and 75% by weight, for example between 50 and 65%,
the polyamide in a percentage between 19.5 and 34.5% by weight, for example between 24 and 34%, or between 24.5 and 49.5%, for example between 34.5 and 49.5%, and
polyurethane in a percentage between 0.5 and 5%, for example between 1 and 3.5%.

For example, the material includes, for a weight percentage of 100%:
a ceramic filler such as a zirconium oxide in a percentage between 65 and 80% by weight, for example between 65 and 75%, or between 50 and 75% by weight, for example between 50 and 65%,
a polyamide, such as a polyamide 11, in a percentage between 19.5 and 34.5% by weight, for example between 24 and 34%, or between 24.5 and 49.5%, for example between 34.5 and 49.5%, and
a polyurethane in a percentage between 0.5 and 5%, for example between 1 and 3.5%.

Such a material combining a ceramic material and a biosourced material of renewable origin is referred to as a bioceramic material.

For example, the material includes a metallic and/or ceramic filler and polyurethane with polyurethane acting both as polymer and as coupling agent. In this example, no separate coupling agent from the polymer is therefore required as the interaction between the filler and the polymer is sufficient to ensure good cohesion of the material after the process.

For example, the material includes a metallic and/or ceramic filler with polyamide as polymer and a hydroxysilane with an amide or amine function as coupling agent, the coupling agent advantageously including at least 20 carbon atoms.

For example, the material includes a metallic and/or ceramic filler with polyester as polymer and a hydroxysilane with an amide or amine function as coupling agent, the coupling agent preferably including at least 20 carbon atoms.

The item is manufactured by moulding, by injection or by 3D printing. The process is characterised by the BET of the powder of the filler which must be sufficient to obtain a reactive surface area. More specifically, the base material for the filler is a powder having a BET specific surface area greater than or equal to 0.01 m²/g, preferably 2 m²/g, more preferably 5 m²/g measured according to the ISO 9277 standard of 2010.

For an injection moulding, the manufacturing process includes the following steps referring to the fillers, polymers, coupling agents, reinforcement and pigments described above:
a) Preparing granules of a few millimetres comprising by weight:
   the metallic and/or ceramic filler having a density greater than or equal to 3 g/cm³, the filler being present in percentage greater than or equal to 50% and less than or equal to 85%, for example between 60 and 80%, for example between 65 and 75%, for example between 50 and 75%, for example between 50 and 65%,
   the polymer(s) present as a whole in a percentage greater than or equal to 15% and less than or equal to 50%, for example between 20 and 40%, for example between 25 and 35%, for example between 25 and 50%, for example between 35 and 50%,
   optionally at least one coupling agent present in a percentage greater than or equal to 0% and less than 10%, advantageously between 0.1 and 10%, more advantageously between 0.1 and 5%, even more advantageously between 0.5 and 3%,
   optionally a reinforcement present in a percentage between 0 and 10%,
   optionally the pigment(s) present in a percentage between 0 and 5%,
   optionally the extender and/or the plasticiser or a mixture of extenders and/or plasticisers, said extender and/or said plasticiser or said mixture of extenders and/or plasticisers being present in a percentage between 0 and 5%.
b) Injection moulding said granules to form the item or a part of the item, for example by over-moulding of another part. The injection is carried out in a mould which has a temperature between 60 and 100° C., preferably between 70 and 80° C., whereas the material during the injection has a temperature between 200 and 300° C., and, preferably, between 250 and 300° C.

In step a), the granules can be manufactured by blanking a column obtained from extruding the raw materials mentioned above. Advantageously, the coupling agent, if it is present, is introduced in a first phase into a hopper of the extruder either separately, or with granules of the polymer before introducing the metallic or ceramic powder in a second phase into the extruder. When the coupling agent is introduced separately, it can be introduced in powder form with a d90 less than or equal to 500 μm and, preferably, 315 μm or in liquid form. The pigment can be introduced during extrusion and advantageously in a second phase. It can also be envisaged to mix polymer with the granules just before extrusion.

According to an alternative embodiment, the metallic, or ceramic, material, and the coupling agent, if it is present, are introduced in a first phase into a hopper of the extruder so as to coat the metallic, or ceramic, powder with the coupling agent before introducing the polymer and the reinforcement.

Alternatively, the item can be manufactured by 3D printing such as by FDM (Fusion Deposition Moulding).

The item thus obtained includes the metallic, and/or ceramic, material and the plastic material comprising the polymer, and optionally the coupling agent, with products from the reaction between the filler, the polymer and the coupling agent during extrusion or injection. It also includes the reinforcement and the pigment, if a pigment and a reinforcement are present.

The item according to the invention has a Young's modulus greater than or equal to 2.5 GPa, an elongation at break greater than or equal to 5% and a tensile strength greater than or equal to 30 MPa, these properties being measured according to the ISO 527-1A standard of 2019.

For example, tests were carried out to manufacture middles by injection from cylindrical granules having a diameter and a length respectively of the order of 4 mm and 1.5 mm.

Tables 1 and 2 hereinafter take two embodiment examples with the resulting properties before and after ageing for 24 h in a ventilated oven with no humidity control at 60° C. Izod machine resilience tests on the middles furthermore demonstrated the good toughness of the middles produced with the compositions mentioned above.

Table 3 illustrates an example of composition of a material according to the invention without the use of a coupling agent.

Table 4 illustrates the composition Comp1 of an item made of a heavy plastic material according to the prior art, particularly according to the document EP3674816.

Table 5 illustrates a first variant Comp2 of the composition Comp1 of the prior art without the use of reinforcing fibre.

Table 6 illustrates a second variant Comp 3 of the composition Comp1 of the prior art wherein the proportions of filler, polymer and coupling agent are similar to the examples according to the invention Inv1, Inv2. Such a variant makes it possible to highlight the advantages and the improvements in cohesion of material obtained with respect to the material described in the document EP3674816.

Table 7 is a summary table assembling the different stiffness, elongation at break and rupture stress properties of the compositions according to the invention (Inv1, Inv2, Inv3) and compositions of the prior art (Comp1, Comp2, Comp3).

By comparing examples 1 (Inv1), 2 (Inv2) and 3 (inv3) with examples 4 (Comp1), 5 (Comp2), 6 (Comp3) of the prior art, the benefit of the specific choice of the polymer for enhancing cohesion with the filler, particularly thanks to the formation of hydrogen bonds with the filler, is shown.

The use of a good coupling agent makes it possible to enhance the properties of the item further (Example 3 and Example 1).

TABLE 1
Example 1-Inv 1

| | Name | Supplier | % by mass |
|---|---|---|---|
| Filler | Carpenter 3120 metal | MIM W08 | 72 |
| | powder | ETA | |
| | Specific surface area: | | |
| | 0.024 m2/g | | |
| Polymer | Polyamide PA11 Rilsan | Arkema | 27 |
| | Clear G820 | (France) | |
| Coupling | Elastollan 1170 | BASF | 1 |
| agent | polyurethane | (Germany) | |

TABLE 2
Example 2-Inv 2

| | | | % |
|---|---|---|---|
| | Name | Supplier | mass |
| Filler | Zirconium Oxide | Comadur | 71 |
| | powder (5% alumina) | | |
| | Specific surface area: | | |
| | 9.5 m2/g | | |
| Polymer | Polyamide PA11 Rilsan | Arkema | 28 |
| | Clear G820 | (France) | |
| Coupling | Elastollan 1170 | BASF | 1 |
| agent | polyurethane | (Germany) | |

TABLE 3
Example 3-Inv 3

| | Name | Supplier | % by mass |
|---|---|---|---|
| Filler | Carpenter 3120 metal | MIM W08 | 72 |
| | powder | ETA | |
| | Specific surface area: | | |
| | 0.024 m2/g | | |
| Polymer | Polyamide PA11 Rilsan | Arkema | 28 |
| | Clear G820 | (France) | |
| Coupling | | | |
| agent | | | |

TABLE 4
Example 4-Composition 1 (Comp1)

| | | | % |
|---|---|---|---|
| | Name | Supplier | mass |
| Filler | Carpenter 3120 metal | MIM W08 | 72 |
| | powder | ETA | |
| | Specific surface area: | | |
| | 0.024 m2/g | | |
| Polymer | MABS Terlux 2802 | Ineos | 18.5 |
| | | Styrolution | |
| Coupling | Coathylene RP 9065- | Axalta | 3.5 |
| agent | 34 | | |
| Reinforcing | 200 μm long glass | Suter- | 6 |
| fibres | fibres | Kunstoffe AG | |

TABLE 5
Example 5-Composition 2 (Comp2)
(composition 1 without reinforcing fibre)

| | | | % |
|---|---|---|---|
| | Name | Supplier | mass |
| Filler | Carpenter 3120 metal | MIM W08 | 72 |
| | powder | ETA | |
| | Specific surface area: | | |
| | 0.024 m2/g | | |
| Polymer | MABS Terlux 2802 | Ineos | 24.5 |
| | | Styrolution | |
| Coupling | Coathylene RP 9065- | Axalta | 3.5 |
| agent | 34 | | |

TABLE 6
Example 6-Composition 3 (Comp3)

| | | | % |
|---|---|---|---|
| | Name | Supplier | mass |
| Filler | Carpenter 3120 metal | MIM W08 | 72 |
| | powder | ETA | |
| | Specific surface area: | | |
| | 0.024 m2/g | | |
| Polymer | MABS Terlux 2802 | Ineos | 27 |
| | | Styrolution | |
| Coupling | Coathylene RP 9065- | Axalta | 1 |
| agent | 34 | | |

TABLE 7
Comparison of examples 1, 2, 3, 4, 5 and 6-Properties before
and after ageing between ()

| | Rigidity-Young's | Elongation at | |
|---|---|---|---|
| | modulus | Break | Rupture Stress |
| Example 1 | 3.0 GPa (3.1 GPa) | 16.3% (15.4%) | 55 MPa (55 MPa) |
| (Inv 1) | | | |
| Example 2 | 4.4 GPa (4.4 GPa) | 9.7% (8.8%) | 63 MPa (61 MPa) |
| (Inv 2) | | | |
| Example 3 | 3.4 GPa | 14.8% | 58 MPa |
| (Inv 3) | | | |
| Example 4 | 2.9 GPa | 8.4% | 23 MPa |
| (Comp 1) | | | |
| Example 5 | 4.4 GPa | 1.8% | 32 MPa |
| (Comp 2) | | | |
| Example 6 | 3.0 GPa | 13.8% | 23 MPa |
| (Comp 3) | | | |

1. An item made of a material having a density between 2 and 7 g/cm³, the material comprising by weight for a total of 100%:
a filler made of a metallic and/or ceramic material having a density greater than or equal to 3 g/cm³, said filler being present in a percentage greater than or equal to 50% and less than or equal to 85%,
at least one polymer present in a percentage greater than or equal to 15% and less than or equal to 50%,
optionally at least one coupling agent present in a percentage greater than or equal to 0% and less than 10%,
optionally at least one reinforcement present in a percentage between 0 and 10%,
optionally at least one pigment present in a percentage between 0 and 5%,
optionally at least one extender and/or one plasticiser present in a percentage between 0 and 5%,
said polymer being bonded to the filler and/or, when the material includes at least one coupling agent, the coupling agent being respectively bonded to the polymer and to the filler by one or more hydrogen bonds;
wherein the polymer, and/or the coupling agent, includes a hydrogen bond donor which is a group NHₓ adjacent to a hydrogen bond acceptor which is a group C═O; so as form a unit —[(C═O)NH]—;
wherein the unit —[(C═O)NH]— represents at least 1% molar of the polymer, and/or the coupling agent.

2. The item according to claim 1, wherein the filler is present in a weight percentage between 60 and 80% and wherein the polymer is present in a weight percentage between 20 and 40%.

3. The item according to claim 1, wherein the filler is present in a weight percentage between 65 and 75% and wherein the polymer is present in a weight percentage between 25 and 35%.

4. The item according to claim 1, wherein the filler is present in a weight percentage between 50 and 75% and wherein the polymer is present in a weight percentage between 25 and 50%.

5. The item according to claim 1, wherein the filler is present in a weight percentage between 50 and 65% and wherein the polymer is present in a weight percentage between 35 and 50%.

6. The item according to claim 1, wherein the coupling agent is present in a weight percentage between 0.1 and 10%.

7. The item according to claim 6, wherein the coupling agent is present in a weight percentage between 0.1 and 5%.

8. The item according to claim 6, wherein the coupling agent is present in a weight percentage between 0.5 and 3%.

9. The item according to claim 1, wherein the metallic and/or ceramic material comprises on the surface oxides, hydroxides and/or electron holes involved in hydrogen, coordination and ionic bonds with the polymer and/or the coupling agent.

10. The item according to claim 1, wherein the polymer and/or the coupling agent carry one or more groups chosen from NHₓ, OH, COC, C═O and COOH.

11. The item according to claim 1, wherein the polymer is a polyamide.

12. The item according to claim 11, wherein the coupling agent is a polyurethane.

13. The item according to claim 1, wherein said polymer is bonded to the filler and/or, when the material includes at least one coupling agent, the coupling agent being respectively bonded to the polymer and to the filler by one or more ionic bonds, the polymer carrying a group NHₓ+ bonded to an anion of the filler and/or the coupling agent.

14. The item according to claim 13, wherein the filler is an anion O—.

15. The item according to claim 13, wherein the coupling agent carries an anion R—COO—.

16. The item according to claim 1, wherein said polymer is bonded to the filler and/or, when the material includes at least one coupling agent, the coupling agent being respectively bonded to the polymer and to the filler by one or more coordination bonds, with the polymer and/or the coupling agent carrying amine or carboxylic acid functions forming said coordination bond with an electron hole on the surface of the filler.

17. The item according to claim 6, wherein the coupling agent includes at least 20 carbon atoms.

18. The item according to claim 1, wherein said material includes the filler and the polymer which is a polyurethane, without addition of said coupling agent.

19. The item according to claim 6, wherein said material includes the filler and polyamide as polymer and polyurethane as coupling agent.

20. The item according to claim 19, wherein said material includes, for a percentage of 100%, said filler in a percentage between 65 and 80%, said polymer in a percentage between 19.5 and 34.5%, and said coupling agent in a percentage between 0.5 and 5%.

21. The item according to claim 20, wherein said material includes, for a percentage of 100%, said filler in a percentage between 65 and 75%, said polymer in a percentage between 24 and 34%, and said coupling agent in a percentage between 1 and 3.5%.

22. The item according to claim 19, wherein said material includes, for a percentage of 100%, said filler in a percentage between 50 and 75%, said polymer in a percentage between 24.5 and 49.5%, and said coupling agent in a percentage between 0.5 and 5%.

23. The item according to claim 22, wherein said material includes, for a percentage of 100%, said filler in a percentage between 50 and 65%, said polymer in a percentage between 34.5 and 49.5%, and said coupling agent in a percentage between 0.5 and 5%.

24. The item according to claim 6, wherein said material includes the filler and polyamide as polymer and hydroxysilane with an amide or amine function as coupling agent.

25. The item according to claim 6, wherein said material includes the filler and polyester as polymer and hydroxysilane with an amide or amine function as coupling agent.

26. The item according to claim 1, wherein the reinforcement is present in a weight percentage between 1 and 6%.

27. The item according to claim 1, wherein the reinforcement is formed of glass fibres, glass beads, carbon fibres and/or aramid fibres.

28. The item according to claim 1, wherein the item consists of a horological external part or movement component.

29. A process for manufacturing an item according to claim 1, comprising:
a) a step of providing base materials for the filler, the polymer, and optionally the coupling agent, the reinforcement and the pigment, with:
the filler made of a metallic and/or ceramic material having a density greater than or equal to 3 g/cm³, said filler being present in a percentage greater than or equal to 50% and less than or equal to 85%,
the polymer present in a percentage greater than or equal to 15% and less than or equal to 50%,
the coupling agent present in a percentage greater than or equal to 0% and less than 10%,
the reinforcement present in a percentage between 0 and 10%,
the pigment present in a percentage between 0 and 5%,
the extender and/or the plasticiser present in a percentage between 0 and 5%,
b) a step of shaping the base materials to produce the item with an injection moulding technique or with a 3D printing technique,
wherein the base material for the filler is a powder having a BET specific surface area greater than or equal to 0.01 m²/g, after the shaping step, said polymer is bonded to the filler and/or, when the material includes at least one coupling agent, the coupling agent is respectively bonded to the polymer and to the filler by one or more hydrogen bonds.
wherein the polymer, and/or the coupling agent, includes a hydrogen bond donor which is a group NHₓ adjacent to a hydrogen bond acceptor which is a group C═O; so as form a unit (C═O)NH;
wherein the unit (C═O)NH represents at least 1% molar of the polymer, and/or the coupling agent.
